(19) United States
(12) Patent Application Publication
(10) Pub. No.: US 2024/0166510 A1
(43) Pub. Date: May 23, 2024

(54) REDUCED METAL DUSTING IN BAYONET REFORMER

(71) Applicant: TOPSOE A/S, Kgs. Lyngby (DK)

(72) Inventors: Jasvant SINGH, Kgs. Lyngby (DK); Kim AASBERG-PETERSEN, Kgs. Lyngby (DK); Steffen Spangsberg CHRISTENSEN, Haldor Topsøes Allé 1 (DK)

(73) Assignee: TOPSOE A/S, Kgs. Lyngby (DK)

(21) Appl. No.: 18/279,594

(22) PCT Filed: Apr. 8, 2022
(86) PCT No.: PCT/EP2022/059431

§ 371 Date: Aug. 30, 2023

(30) Foreign Application Priority Data
Apr. 13, 2021 (IN) 202111017222
Jun. 25, 2021 (EP) 21181660.8

(51) Int. Cl. C01B 3/38; B01J 8/04; B01J 8/06; C01B 3/48; C01B 3/50

(52) U.S. Cl. CPC C01B 3/382; B01J 8/0492; B01J 8/065; B01J 8/067; C01B 3/384; C01B 3/48; C01B 3/50; B01J 2208/00194; B01J 2208/00504; B01J 2208/065; C01B 2203/0233; C01B 2203/0283; C01B 2203/0827; C01B 2203/0833; C01B 2203/1241; C01B 2203/127; C01B 2203/143

(57) ABSTRACT

A system is provided for reforming a hydrocarbon feedstock. The system comprises: first prereformer units and first preheating unit arranged upstream a bayonet tube steam methane reformer. The system is arranged to provide a temperature of the heated partially-reformed process stream at the inlet of the bayonet tube steam methane reformer of at least 600° C. and a temperature of the gas at the bottom of the bayonet steam methane reformer tubes of at least 800° C. This arrangement allows higher bayonet tube inlet temperatures, with reduced risk of increased metal dusting. A process is also provided for reforming a hydrocarbon feedstock in the system of the invention.

### TECHNICAL FIELD

A system is provided for reforming a hydrocarbon feedstock. The system comprises at least a first prereformer unit and a first preheating unit arranged upstream a bayonet tube steam methane reformer. Higher bayonet tube inlet temperatures allow a reduced risk of increased metal dusting. A process is also provided for reforming a hydrocarbon feedstock in the system of the invention.

### BACKGROUND

A type of heat exchange reactor presently used in industrial applications is the bayonet tube reactor. Conventional bayonet tube reactors consist of an inner tube coaxially arranged in an outer sheath tube. Catalyst particles are loaded in an annular space defined between the walls of the inner tube and the outer tube. A process stream of reactants is reacted by passing the stream through the catalyst in heat conducting relationship with heat conducting medium flowing externally along the wall of the sheath tube. Heat for endothermic reactions is partially supplied by the burners e.g. located on the side walls of a furnace box of a reformer. When used in heat requiring endothermic reactions, part of the heat for the reactions in the process stream is supplied by indirect heat exchange with the process stream in the tube. Having passed through the catalyst, the reacted process stream impinges against the closed end of the outer tube, where the stream reverses its direction to the inner tube of the reactor, and is then withdrawn from the reactor as product stream.

Use of bayonet tube reactors in steam reforming of a hydrocarbon process stream is disclosed in European Patent Application No. 334,540, GB Patent Application No. 2,213,496 and in European Patent Application No. 194,067.

A higher inlet temperature to the reformer increases the risk of metal dusting in heating coils. Metal dusting is a process, which can destroy metal through carburization. A prerequisite for metal dusting to occur is the affinity of the gas, which is in contact with the metal, for carbon formation. The phenomenon is of particular importance when dealing with synthesis gas (syngas), because it has been found that CO is the most potent metal dusting molecule. Furthermore, it has been found that the presence of hydrogen tends to accelerate the process.

The present technology aims to address the problems associated with metal dusting in bayonet tube steam methane reforming reactors at elevated temperatures.

### SUMMARY

A system for reforming a hydrocarbon feedstock is thus provided, said system comprising:
a first prereformer unit, arranged to receive a hydrocarbon feedstock and a first steam feed and convert them to a first partially-reformed process stream,
a first preheating unit arranged to heat at least a portion of the first partially-reformed process stream,
a bayonet tube steam methane reformer, arranged to receive the heated, partially-reformed process stream from the preheating unit and convert it to a syngas stream.
said system being arranged to provide a temperature of the heated partially-reformed process stream at the inlet of the bayonet tube steam methane reformer of at least 600° C.;
said system also being arranged to provide a temperature of the gas at the bottom of the bayonet steam methane reformer tubes of at least 800° C.

A further system for reforming a hydrocarbon feedstock is provided, said system comprising:
a first prereformer unit, arranged to receive a hydrocarbon feedstock and a first steam feed and convert them to a first partially-reformed process stream,
a first preheating unit arranged to heat at least a portion of the first partially-reformed process stream,
a second prereformer unit, arranged to receive the heated first partially-reformed process stream and convert it to a second partially-reformed process stream,
a second preheating unit arranged to heat at least a portion of the second partially-reformed process stream,
a bayonet tube steam methane reformer, arranged to receive the heated, second partially-reformed process stream from the second preheating unit and convert it to a syngas stream.

A process is also provided for reforming a hydrocarbon feedstock, in the systems described herein.

It has been found that the use of these systems and processes can increase the bayonet tube top temperature, while reducing or eliminating the risk of increased metal dusting in the feed preheat coil and the bayonet tube steam methane reformer (also called “SMR-b).

Additional aspects are set out in the dependent claims, the figures and the following description text.

Legends

The technology is described with reference to the enclosed schematic figures, in which:

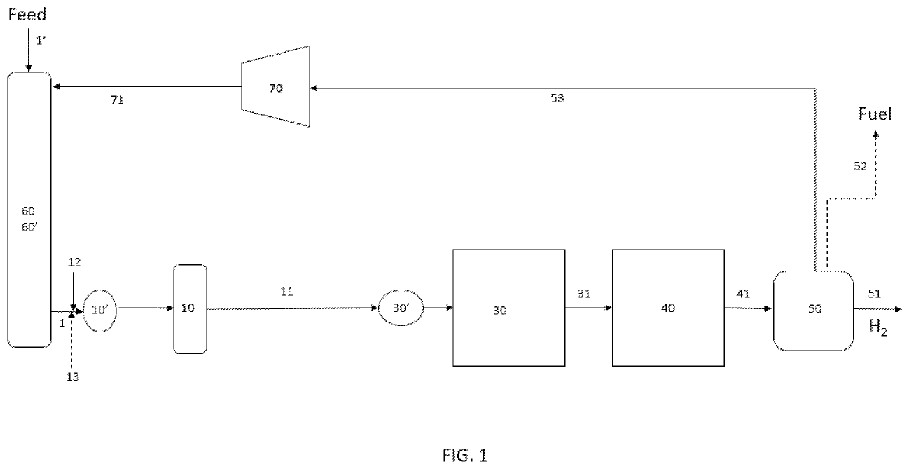

FIG. 1 shows a system according to the invention including first prereformer unit, as well as a bayonet tube steam methane reformer

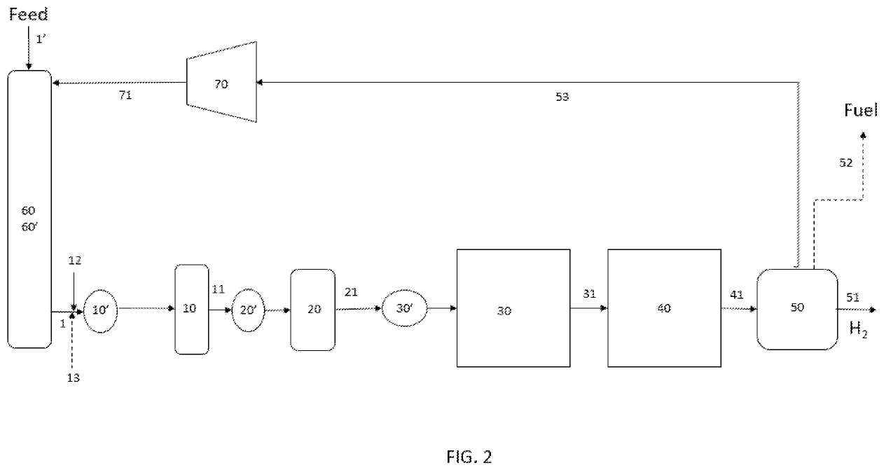

FIG. 2 shows a system according to the invention including first and second prereformer unit as well as a bayonet tube steam methane reformer.

### DETAILED DISCLOSURE

Unless otherwise specified, any given percentages for gas content are % by volume.

The term “synthesis gas” is used interchangeably with the term “syngas” and is meant to denote a gas comprising hydrogen, carbon monoxide and also carbon dioxide and small amounts of other gasses, such as argon, nitrogen, methane, etc.

The bayonet tube inlet temperature is defined as the temperature of feed inlet to a bayonet reformer.

### Specific Embodiments

As noted above, and as illustrated in the Figures, a system is provided for reforming a hydrocarbon feedstock. “Reforming” is indicated generally by the reaction:

CnHm+nH2O=nCO+(1/2m+n)H2
and particularly includes so-called “higher hydrocarbon reforming”, in which n is two or more. A specific reforming reaction is the steam methane reforming (SMR) process, indicated generally by the reaction:

CH₄+H₂O [symbol] CO+3H₂

The reforming reaction is accompanied by the water gas shift reaction:

CO+H₂O═CO₂+H₂

In general terms, the system comprises (in order):
a first prereformer unit
a first preheating unit,
optionally, a second prereformer unit
optionally, a second preheating unit
a bayonet tube steam methane reformer (SMR-b).

The hydrocarbon feedstock for the system/process denotes a gas with one or more hydrocarbons and possibly other constituents. Thus, typically the hydrocarbon feedstock comprises a hydrocarbon gas, such as CH₄ and usually also higher hydrocarbons often in relatively small amounts, in addition to various amounts of other gasses such as carbon monoxide, carbon dioxide, nitrogen and argon. “Higher hydrocarbons” are components with two or more carbon atoms such as ethane and propane. Examples of “hydrocarbon feedstock” may be natural gas, town gas, naphtha or a mixture of methane and higher hydrocarbons, biogas or LPG. The term “hydrocarbon” also includes oxygenates.

Typically, the hydrocarbon feedstock will have undergone a purification step (e.g. a desulfurization step) to remove impurities therein prior to being inlet into the SMR-b. This reduces or avoids deactivation of the catalysts in the SMR-b.

In one aspect, therefore, the system may further comprise at least one purification unit, such as a hydrodesulfurisation (HDS) unit, upstream the first prereformer unit, said purification unit being arranged to provide said hydrocarbon feedstock from a raw hydrocarbon feedstock. Substances other than sulfur that might need to be removed in a purification step include chlorine, dust and heavy metals.

Following purification, the hydrocarbon feedstock is subjected to at least one, and preferably at least two prereforming steps, prior to being fed to the bayonet tube steam methane reformer (SMR-B). As noted above, the system therefore comprises a first prereformer unit, and optionally, a second prereformer unit. Additional prereformer units may be included as required.

The hydrocarbon feedstock will, together with steam feed, (and potentially also other components such as carbon dioxide), undergo prereforming in a temperature range of ca. 350-700° C. to convert higher hydrocarbons as an initial step in the process. Optionally, carbon dioxide or other components may also be mixed with the partially-reformed process streams leaving each prereforming step.

Prereformer units used in the present invention are catalyst-containing reactor vessels, and are typically adiabatic. In the prereforming units, heavier hydrocarbon components in the hydrocarbon feedstock are steam reformed and the products of the heavier hydrocarbon reforming are shifted. The skilled person can construct and operate suitable prereformer units as required. Prereformer units suitable for use in the present system/process are provided in applicant's co-pending applications EP20201822 and EP21153815.

Catalyst volumes and operating temperatures between the different prereformer units are usually different. It is expected that the catalysts in e.g. first and second prereformer units are the same type, but in some cases the catalysts may be different from the first and second reformer units.

The first prereformer unit is arranged to receive a hydrocarbon feedstock and a first steam feed and convert them to a first partially-reformed process stream. The hydrocarbon feedstock and first steam feed are suitably mixed prior to being fed to the first prereformer unit.

The first partially-reformed process stream comprises methane, hydrogen, carbon monoxide, steam and also carbon dioxide. The first partially-reformed process stream at the outlet of the first prereformer may be in the temperature range: 400° C.-500° C. In particular, the gas composition of the first partially-reformed process stream from the first prereformer may—depending on feedstock—be as follows:
H₂=6.5-10 mol %
H₂O=50-80 mol %
CO=0.001-0.5 mol %
CO₂=1.5-10 mol %
CH₄=25-35 mol %

The first steam feed—and any other steam feeds potentially required by the system/process—may be provided by process steam generally available in chemical plants. It constitutes >95% H₂ O, preferably >99% H₂O.

A first preheating unit is arranged (downstream the first prereformer unit) to heat at least a portion of the first partially-reformed process stream. The first preheating unit is adapted to heat a portion of the first partially-reformed process stream, e.g. to a temperature of at least 600° C., preferably at least 650° C. and more preferably at least 700° C., such as at least 750° C. The first preheating unit suitably comprises one or more coils through which the first partially-reformed process stream is passed, where the coils are heated externally, e.g. by combustion of a fuel.

A second prereformer unit may be arranged to receive the heated, first partially-reformed process stream (from the first preheating unit) and convert it to a second partially-reformed process stream. The second partially-reformed process stream comprises methane, hydrogen, carbon monoxide and also carbon dioxide. The second partially-reformed process stream at the outlet of the second prereformer may be in the temperature range: 500° C.-650° C.

In particular, the gas composition of the second partially-reformed process stream from the second prereformer may be as follows:
H₂=13-20 mol %
Water=50-70 mol %
CO=0.2-0.8 mol %
CO 2=2-8 mol %
CH₄=20-40 mol %

A second preheating unit is suitably arranged (downstream the second prereformer unit) to heat at least a portion of the second partially-reformed process stream. The second preheating unit is adapted to heat a portion of the second partially-reformed process stream, e.g. to a temperature of at least 650° C., preferably at least 700° C., more preferably at least 750° C., such as at least 800° C. The second preheating unit suitably comprises one or more coils through which the second partially-reformed process stream is passed, where the coils are heated externally, e.g. by combustion of a fuel. Additional prereformers may be installed in series to the first two prereformers. This will improve the plant energy efficiency.

The system may further comprise an additional preheating unit located upstream the first prereformer unit and arranged to heat the hydrocarbon feedstock and said first steam feed.

In other words, preheating units are suitably present upstream each prereformer unit. The additional preheating unit may also take the form of one or more coils, through which the relevant feed or stream is passed, while the coils are heated externally. In one particular configuration, the first, second and additional preheating units are all heated by the same heat source.

Both the first and second partially-reformed process streams are completely in the gas phase.

The system comprises a bayonet tube steam methane reformer (SMR-B) arranged to receive a heated, partially-reformed process stream from the preheating unit and convert it to a syngas stream.

In the case where only the first prereformer and first preheating unit are present, the bayonet tube steam methane reformer is arranged to receive the heated, first partially-reformed process stream.

In the case where first and second prereformers and first and second preheating units are present, the bayonet tube steam methane reformer is arranged to receive the heated, second partially-reformed process stream.

In a first aspect, the system is arranged to provide a temperature of the heated partially-reformed process stream at the inlet of the bayonet tube steam methane reformer of at least 600° C.. The system is also arranged to provide a temperature of the gas at the bottom of the bayonet steam methane reformer tubes of at least 800° C. As metal dusting is an exothermic reaction, high inlet and high bottom temperatures increase the bayonet tube wall temperature, and thus reduce the risk of metal dusting.

Bayonet tube steam methane reformers (SMR-b) combine properties of convection and radiant heat transfer in one steam reformer. Bayonet reformers are primarily used to produce hydrogen and synthesis gas by steam reforming of hydrocarbon feed stocks.

A bayonet tube steam methane reformer (SMR-b) comprises a plurality of parallel bayonet reformer tubes filled with catalyst. The plurality of bayonet reformer tubes are located within a furnace box, and may be heated by means of one or more heating elements (e.g. radiant wall burners) and/or convective heat exchange.

Bayonet reformers can provide hydrogen production with minimum hydrocarbon consumption and low steam export. A bayonet tube steam methane reformer is configured to use a hot gas to supply the heat for the endothermic steam methane reforming reactions by heat exchange, typically over a tube wall. Such a reformer has several parallel tubes filled with catalyst which receive the feed gas. The feed gas is fed into the top of the bayonet reformer tubes and reacts as it flows to the bottom of the tubes. The bayonet reformer tubes may be arranged in a “bundle”, or in a single plane.

The reformer furnace is typically constructed of steel, with insulating material (such as ceramic material) arranged as required to maintain internal temperatures while protecting external structures from excessive temperatures. The flue gas leaving the reformer normally has a temperature between 1000-1100° C.

This flue gas leaving the reformer is usually considered waste heat used for steam generation for export. In an embodiment of particular interest, preheating in said first, second and additional preheating units takes place via heat exchange with the flue gas from the bayonet steam methane reformer, SMR-b. In this embodiment, waste heat is recycled back into the process and because of that less fuel needs to be burned.

One or more heating elements may be present within the enclosed volume of the reformer furnace. Suitably, the heating elements are gas burners. Typically, the heating elements are distributed evenly throughout the enclosed volume of the reformer furnace, so that the furnace is heated evenly throughout the enclosed volume. In one embodiment, heating element(s) are mounted at the bottom of the bayonet reformer.

In an embodiment, the steam reforming unit is a convection reformer comprising one or more bayonet reforming tubes such as a convective reformer i.e. Topsøe bayonet reformer, where the heat for reforming is transferred by convection along with radiation. In this embodiment of the SMR-b, there are no heating elements. EP 0535505 provides a description of such a convective reformer.

The reformer furnace comprises at least one bayonet reformer tube located at least partly within said enclosed volume. The bayonet reformer tube is as described generally in EP535505—hereby incorporated by reference. The terms “bayonet reformer tube” and “reformer tube” are used interchangeably in this text.

In a steam reforming process, a stream of hydrocarbons and steam is catalytically reformed to a product stream of hydrogen and carbon oxides; typified by the following reactions:
CH₄+H₂O→CO+3H₂ ΔH°₂₉₈=−49.3 kcal/mole
CH₄+2H₂O→CO₂+4H₂ ΔH°₂₉₈=−39.4 kcal/mole

Suitable process conditions (temperatures, pressures, flow rates etc.) and suitable catalysts for such steam reforming processes are known in the art.

In general terms, the bayonet reformer tube comprises an outer tube, and an inner tube arranged within said outer tube. A catalyst bed is arranged between the inner and outer tubes. As noted above, the bayonet reformer tube is arranged such that hydrocarbon feed entering the bayonet reformer tube via a feed gas inlet passes along the outer tube, where it is converted to synthesis gas over the catalyst bed. The synthesis gas thus produced passes along the inner tube before exiting the bayonet reformer tube via said process gas outlet.

Steam reforming reactions are initiated by contact with a bed of steam reforming catalyst in the reformer tube at temperatures above 350° C., e.g. in the range 550° C.-800° C. In order to ensure a high conversion of hydrocarbons, the temperature of the hydrocarbon stream is gradually raised during its passage through the catalyst bed. Having passed through the catalyst the reacted process stream leaves the catalyst at the outlet end of the outer reformer tube as a product stream at temperatures between 700° C. and 950° C. Necessary heat for the endothermic reforming reactions proceeding in the catalyst is supplied by radiation from the heated furnace walls. The design of the bayonet reformer tube allows additional heat exchange to take place between the synthesis gas passing along the inner tube with the catalyst bed and gas located in the outer tube.

The bayonet reformer tube has a generally cylindrical form. A feed gas inlet for hydrocarbon feed and a process gas outlet for said synthesis gas stream are arranged in the same end of the bayonet reformer tube.

The feed gas inlet for the hydrocarbon feed and the process gas outlet for the synthesis gas stream of each bayonet reformer tube are arranged outside the enclosed volume of the reformer furnace. This simplifies construction and allows ready access to the inlet/outlet without having to access the inside of the reformer furnace.

There is risk of metal dusting in the bayonet tube due to the following reactions
The CO reduction reaction: CO+H₂═C+H₂O
The Boudouard Raeaction: 2CO═C+CO₂

The two reactions usually take place at a temperature range between 475° C.-850° C. These reaction are extremely exothermic, which also means that thermodynamic potential for metal dusting increasing at lower metal surface temperature as the reaction would move in forward direction at lower temperature and produce more “C”.

For more information on these reformers, details are herein provided by direct reference to Applicant's patents and/or literature. For instance, for tubular and autothermal reforming an overview is presented in “Tubular reforming and autothermal reforming of natural gas—an overview of available processes”, lb Dybkjaer, Fuel Processing Technology 42 (1995) 85-107.

The use of two or more prereformers in series can reduce or totally eliminate slip of higher hydrocarbons to the reformer. This allows the second partially-reformed process stream to be heated to a higher temperature than would otherwise be possible, while reducing the risk of cracking of higher hydrocarbons.

An increased preheat temperature of the feed gas increases the risk of carbon formation in the preheat coil due to slip of higher hydrocarbons from the prereformer. This can be mitigated by adding an additional prereformer in series and switching the preheating coils to lower surface temperature. This reduces risk of hydrocarbon slip and carbon formation compared to conventional layouts

With the current invention the SMR-b inlet gas can be preheated to 650° C. or more, while the SMR-B bayonet tube bottom temperature can be increased without the risk of increased metal dusting in SMR-b feed preheat coil and bayonet tube. This results in a very high energy efficient hydrogen generation unit.

The layout illustrated in FIG. 1 preheats up to 650° C. at the inlet of SMR-b with one prereformer upfront.

The layout illustrated in FIG. 2 uses two or more prereformers in series, with a first preheating unit between these prereformers, followed by a second preheating unit to preheat prereformed gas to at least 600° C., preferably at least 650° C., more preferably at least 700° C. or at least 750° C.

Using the system and process disclosed herein, the bayonet tube bottom temperature can be at least 800° C., preferably at least 880° C., more preferably at least 900° C., such as at least 920° C. or even higher.

Various units may be located downstream the bayonet tube steam methane reformer, depending on the final use of the syngas stream from said SMR-b.

For instance, a shift unit may be arranged downstream the bayonet tube steam methane reformer, said shift unit being arranged to receive the syngas stream and convert it to a hydrogen-rich stream.

A hydrogen purification unit may also be arranged downstream the shift unit, said hydrogen purification unit being arranged to receive the hydrogen-rich stream and convert it to a purified hydrogen stream.

The system may further comprise a hydrogen recycle unit downstream the hydrogen purification unit, said hydrogen recycle unit being arranged to receive part of the hydrogen-rich stream and recycle it to said purification unit. This part of the hydrogen-rich stream can then be used in the purification step, e.g. sulfur removal via formation of H₂S. A hydrogen-rich stream can be taken upstream or downstream H₂ purification unit. Hydrogen-rich stream is used for hydrogenation reactions in the purification step, such as converting sulfur and chlorine to H₂S and HCl. Hydrogen rich stream may also be used for the reforming reactions taking place in the prereformers.

The presence of hydrogen in the first prereformer unit can help avoid oxidation of the prereformer catalyst. If additional hydrogen is required, the system may further comprise an (external) hydrogen feed arranged upstream the first prereformer unit, preferably upstream said purification unit. The hydrogen feed used suitably comprises more than 95%, such as more than 98% or more than 99% by volume H₂.

A process for reforming a hydrocarbon feedstock is also provided, in the system(s) described herein. All details of the above-described system are relevant to the herein-described process, mutatis mutandis.

The process comprises the general steps of:
feeding a hydrocarbon feedstock and a first steam feed to a first prereformer unit, and converting them therein to a first partially-reformed process stream,
heating at least a portion of the first partially-reformed process stream in a first preheating unit,
feeding the heated, partially-reformed process stream to a bayonet tube steam methane reformer, and converting it therein to a syngas stream
wherein the temperature of the partially-reformed process stream at the inlet of the bayonet steam methane reformer is at least 600° C., and
wherein the temperature of the gas at the bottom of the bayonet steam methane reformer tubes is at least 800° C.

In this process, the system may further comprise an additional preheating unit located upstream the first prereformer unit, and wherein said process further comprises a step of heating the hydrocarbon feedstock and said first steam feed in said additional preheating unit. Typically, the hydrocarbon feedstock and said first steam feed are heated to a temperature between 350° C. and 550° C.

The temperature of the heated partially-reformed process stream at the inlet of the bayonet steam methane reformer is preferably at least 650° C., more preferably at least 700° C., such as at least 730° C.. Similarly, the temperature of the gas at the bottom of the bayonet steam methane reformer tubes is preferably at least 880° C., more preferably at least 900° C., such as at least 930° C..

If only first prereformer and first preheating unit are present, the heated, partially-reformed process stream fed to the bayonet tube steam methane reformer is the heated, first partially-reformed process stream.

One particular aspect of the process comprises the further steps of:
feeding the heated first partially-reformed process stream to a second prereformer unit, and converting it therein to a second partially-reformed process stream,
heating at least a portion of the second partially-reformed process stream in a second preheating unit,
and feeding the heated, second partially-reformed process stream to the bayonet tube steam methane reformer, and converting it therein to a syngas stream;
wherein the temperature of the second partially-reformed process stream at the inlet of the bayonet steam methane reformer is at least 600° C., preferably at least 650° C., more preferably at least 700° C., such as at least 750° C..

In the step of heating said portion of the first partially-reformed process stream which is fed to the second prereformer unit in said first preheating unit, the first partially-reformed process stream is typically heated to a temperature between 300° C. and 700° C..

### DETAILED DESCRIPTION OF THE FIGURES

FIG. 1 shows a system according to the invention, including a bayonet tube steam methane reformer, in which only one prereformer unit is present. Raw hydrocarbon feedstock 1′ is purified in purification unit 60 to provide hydrocarbon feedstock 1. This feedstock 1 is mixed with a first steam feed 12. The combined feed is heated in an additional preheating unit 10′ and then converted in a first prereformer unit 10 to a first partially-reformed process stream 11. First partially-reformed process stream 11 is fed to the bayonet tube steam methane reformer 30, via preheating unit 30′.

The layout of FIG. 1 also includes:
shift unit 40 being arranged to receive the syngas stream 31 and convert it to a hydrogen-rich stream 41
hydrogen purification unit 50 being arranged to receive the hydrogen-rich stream 41 from the shift unit and convert it to a purified hydrogen stream 51. Hydrogen purification unit 50 also provides off gas 52, which can be provided as fuel to another part of the layout
hydrogen recycle unit 70 being arranged to receive part of hydrogen-rich stream 53 and recycle it to said purification unit 60
hydrogen feed 13

FIG. 2 shows a system according to the invention including a bayonet tube steam methane reformer. Elements in FIG. 2 correspond to those described for FIG. 1.

The difference between FIG. 2 and FIG. 1 lies in that a first preheating unit 20′ is arranged to heat at least a portion of the first partially-reformed process stream 11 from the first prereformer, and in that a second prereformer unit 20 is arranged to receive at least a portion of the heated first partially-reformed process stream 11 from the first preheating unit 20′ and convert it to a second partially-reformed process stream 21.

As indicated in the layout of FIG. 2, the SMR-B inlet temperature can be increased to 700° C. from 650° C. as used in the SMR-B layout of FIG. 1. In this layout two prereformers in series are able to heat 700° C. at the inlet of the SMR-B. Two prereformers help to reduce carbon potential avoid carbon formation in the feed preheating coil in case there is a slip of higher hydrocarbon from the first pre-reformer. Carbon activities are lower as compared with the layout of FIG. 1, which has the same or lower surface temperature. Hence a reduced potential for metal dusting is foreseen.

### Examples

Thermodynamic potential for metal dusting is evaluated by carbon activity, which is defined as indicated below:

Carbon activity, A_{c}
1. Boudouard Reaction: 2CO═C+CO₂, A_{c}=k₁*P_{co}²/P_{co2}
2. CO reduction reaction: CO±H₂=C+H₂O, A_{c}=K₂*P_{co}*P_{H2}/P_{H2O}

K1 and K2 are the equilibrium constants for reactions 1 and 2 and are evaluated using the following equation (cf. Concepts in syngas manufacturing by Jens Rostrup-Nielsen and Lars J. Christiansen, vol. 10):
Ln(K)═C₁*In(T)+C₂/T+C₃+C₄*T+C₅*T²+C₆*T³

Values of constants for both the reactions are tabulated below

| Constants | Boudouard reaction | CO reduction |
|---|---|---|
| C1 | −3.635623 | −3.319458 |
| C2 | 20053.64 | 15037.16 |
| C3 | 0.3805679 | 4.484935 |
| C4 | 0.005096533 | 0.00295691 |
| C5 | −1.16153E−06 | −5.57093E−07 |
| C6 | 1.33663E−10 | 5.78377E−11 |

T is temperature in ⁰K

Theoretical risk of carbon formation is present, if A_{c}>1

### 1.1 Simulation Results—Table 1

Simulations were carried out of layouts according to FIG. 1, without second prereformer, at different SMR-b inlet temperatures-550° C. (case 1A), 650° C. (case 2A) and 700° C. (case 3A).

The layout indicated in FIG. 2, with second prereformer, was also simulated at different SMR-b inlet temperatures—550° C. (case 1B), 650° C. (case 2B) and 700° C. (case 3B).

The SMR-B bottom temperature was kept at 930° C. in all cases, in order to maintain the same gas composition.

TABLE 1

| | | Case 1 | | Case 2 | | Case 3 | |
|---|---|---|---|---|---|---|---|
| Governing | | Case | Case | Case | Case | Case | Case |
| parameters | Units | 1A | 1B | 2A | 2B | 3A | 3B |
| Temp inlet SMR-B, | ° C. | 550 | 550 | 650 | 650 | 700 | 700 |
| SMR-B bottom | ° C. | 930 | 930 | 930 | 930 | 930 | 930 |
| temperature | | | | | | | |
| 2nd prereformer | ° C. | N/A | 650 | N/A | 650 | N/A | 650 |
| inlet temperature | | | | | | | |
| Min SMR-B Tube | | 625 | 650 | 651 | 677 | 664 | 686 |
| skin temperature | | | | | | | |
| Carbon Activity, Ac | | 22 | 13 | 13 | 8 | 10 | 6 |

### 1.2 CONCLUSION

An increased preheat temperature of the feed gas (simulation 1A->2A->3A) increases the tube skin temperature, thus reducing the likelihood of C formation (as determined by the Carbon Activity).

At the same time, increased preheat temperature of the feed gas increases the risk of carbon formation in the preheat coil due to slip of higher hydrocarbons from the prereformer.

This can be mitigated by adding an additional prereformer in series and switching the preheating coils to lower surface temperature. This provides increased SMR-b Tube skin temperature, while—at the same time—reducing the likelihood of C formation (as determined by the Carbon Activity).

The present invention has been described with reference to a number of aspects and embodiments. These aspects and embodiments may be combined at will by the person skilled in the art while remaining within the scope of the patent claims.

1. A system for reforming a hydrocarbon feedstock, said system comprising:
a first prereformer unit, arranged to receive a hydrocarbon feedstock and a first steam feed and convert them to a first partially-reformed process stream,
a first preheating unit arranged to heat at least a portion of the first partially-reformed process stream,
a bayonet tube steam methane reformer, arranged to receive a heated partially-reformed process stream from the first preheating unit and convert it to a syngas stream
said system being arranged to provide a temperature of the heated partially-reformed process stream at the inlet of the bayonet tube steam methane reformer of at least 600° C.;
said system also being arranged to provide a temperature of the gas at the bottom of the bayonet steam methane reformer tubes of at least 800° C.

2. The system according to claim 1, said system being arranged to provide a temperature of the heated partially-reformed process stream at the inlet of the bayonet tube steam methane reformer of at least 650° C..

3. The system according to claim 1, said system being arranged to provide a temperature of the gas at the bottom of the bayonet steam methane reformer tubes of at least 880° C..

4. The system according to claim 1, said system further comprising:
a second prereformer unit, arranged to receive the heated first partially-reformed process stream from the first preheating unit and convert it to a second partially-reformed process stream
a second preheating unit arranged to heat at least a portion of the second partially-reformed process stream; and
a bayonet tube steam methane reformer arranged to receive the heated, second partially-reformed process stream from the second preheating unit and convert it to a syngas stream.

5. A system for reforming a hydrocarbon feedstock, said system comprising:
a first prereformer unit, arranged to receive a hydrocarbon feedstock and a first steam feed and convert them to a first partially-reformed process stream,
a first preheating unit arranged to heat at least a portion of the first partially-reformed process stream,
a second prereformer unit, arranged to receive the heated first partially-reformed process stream from the first preheating unit and convert it to a second partially-reformed process stream, and
a second preheating unit arranged to heat at least a portion of the second partially-reformed process stream;
a bayonet tube steam methane reformer arranged to receive the heated, second partially-reformed process stream from the second preheating unit and convert it to a syngas stream.

6. The system according to claim 4, wherein the second preheating unit is adapted to heat said portion of the second partially-reformed process stream to a temperature of at least at least 600° C..

7. The system according to claim 1, further comprising a shift unit downstream the bayonet tube steam methane reformer, said shift unit being arranged to receive the syngas stream and convert it to a hydrogen-rich stream.

8. The system according to claim 1, further comprising a hydrogen purification unit downstream the shift unit, said hydrogen purification unit being arranged to receive the hydrogen-rich stream and convert it to a purified hydrogen stream.

9. The system according to claim 1, further comprising at least one purification unit, upstream the first prereformer unit, said purification unit being arranged to provide said hydrocarbon feedstock from a raw hydrocarbon feedstock.

10. The system according to claim 9, further comprising a hydrogen recycle unit downstream the hydrogen purification unit, said hydrogen recycle unit being arranged to receive part of hydrogen-rich stream and recycle it to said purification unit.

11. The system according to claim 1, further comprising an additional preheating unit located upstream the first prereformer unit and arranged to heat the hydrocarbon feedstock and said first steam feed.

12. The system according to claim 1, wherein flue gas from the bayonet steam methane reformer, is arranged to provide heat to said first, second and additional preheating units.

13. The system according to claim 1, further comprising a hydrogen feed arranged upstream the first prereformer unit.

14. A process for reforming a hydrocarbon feedstock, in the system according to claim 1, said process comprising the steps of:
feeding a hydrocarbon feedstock and a first steam feed to a first prereformer unit, and converting them therein to a first partially-reformed process stream, heating at least a portion of the first partially-reformed process stream in a first preheating unit,
feeding the heated, partially-reformed process stream to a bayonet tube steam methane reformer, and converting it therein to a syngas stream
wherein the temperature of the partially-reformed process stream at the inlet of the bayonet steam methane reformer is at least 600° C., and
wherein the temperature of the gas at the bottom of the bayonet steam methane reformer tubes is at least 800° C.

15. The process according to claim 14, wherein the temperature of the partially-reformed process stream at the inlet of the bayonet steam methane reformer is at least 650° C..

16. The process according to claim 14, wherein the temperature of the gas at the bottom of the bayonet steam methane reformer tubes is at least 880° C..

17. The process according to claim 14, further comprising the steps of
feeding the heated first partially-reformed process stream to a second prereformer unit, and converting it therein to a second partially-reformed process stream,
heating at least a portion of the second partially-reformed process stream in a second preheating unit,
and feeding the heated, second partially-reformed process stream to the bayonet tube steam methane reformer, and converting it therein to a syngas stream; wherein the temperature of the second partially-reformed process stream at the inlet of the bayonet steam methane reformer is at least 600° C..

18. The process according to claim 14, wherein said system further comprises an additional preheating unit located upstream the first prereformer unit, and wherein said process further comprises a step of heating the hydrocarbon feedstock and said first steam feed in said additional preheating unit.

19. The process according to claim 14, further comprising the step of feeding flue gas from the bayonet steam methane reformer to said first, second and additional preheating units, and heating feedstock or process stream therein by heat exchange with said flue gas.
